(19) United States
(12) Patent Application Publication
(10) Pub. No.: US 2026/0138593 A1
(43) Pub. Date: May 21, 2026

(54) AUTOMATED VALET PARKING SYSTEM AND COMMUNICATION INTERFACE SPECIFICATION UPDATE METHOD

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/353,531

(22) Filed: Oct. 8, 2025

(30) Foreign Application Priority Data
Nov. 15, 2024 (JP) 2024-199561

(51) Int. Cl. B60W 30/06; G06Q 10/02

(52) U.S. Cl. CPC B60W 30/06; G06Q 10/028; B60W 2556/45

(57) ABSTRACT

An automated valet parking (AVP) system is for AVP of a vehicle in a parking lot. Communication between the vehicle and a parking lot system is required for the AVP. An IF specification version is a version of a communication interface specification for the communication. A vehicle-side IF version is an IF specification version supported by the vehicle. One or more parking lot-side IF versions are one or more IF specification versions supported by the parking lot system. A target IF version is any of the one or more parking lot-side IF versions. When the vehicle-side IF version is not included in the one or more parking lot-side IF versions, the AVP system suggests updating the vehicle-side IF version to the target IF version to a user of the vehicle, or automatically updates the vehicle-side IF version to the target IF version.

### CROSS-REFERENCES TO RELATED APPLICATION

The present disclosure claims priority to Japanese Patent Application No. 2024-0199561, filed on November 15, 2024, the contents of which application are incorporated herein by reference in their entirety.

### TECHNICAL FIELD

The present disclosure relates to automated valet parking (AVP: Automated Valet Parking) in a parking lot.

### BACKGROUND ART

Patent Literature 1 discloses automated valet parking in a parking lot. A vehicle that supports the automated valet parking acquires route information from a parking lot system and autonomously travels along the acquired route.

Non-Patent Literature 1 discloses a standard related to the automated valet parking.

### List of Related Art

Patent Literature 1: German Patent Application Publication No. 102012222562

Non-Patent Literature 1: "Automated Valet Parking Systems, Requirements for automated valet parking systems", German Association of the Automotive Industry, Version 1.0, March 2023.

### SUMMARY

In order to realize automated valet parking in a parking lot, it is necessary to perform a communication between a vehicle and a parking lot system (infrastructure system). Here, it is desirable that a version of a communication interface specification matches between the vehicle side and the parking lot system side. If the version of the communication interface specification does not match between the vehicle side and the parking lot system side, there is a possibility that the automated valet parking cannot be started.

A first aspect relates to an automated valet parking system for automated valet parking of a vehicle in a parking lot.

A parking lot system is a system that manages the automated valet parking in the parking lot. A communication between the vehicle and the parking lot system is required for the automated valet parking.

An IF specification version is a version of a communication interface specification for the communication. A vehicle-side IF version is an IF specification version supported by the vehicle. One or more parking lot-side IF versions are one or more IF specification versions supported by the parking lot system. A target IF version is any of the one or more parking lot-side IF versions.

The automated valet parking system includes one or more processors. When the vehicle-side IF version is not included in the one or more parking lot-side IF versions, suggest updating the vehicle-side IF version to the target IF version to a user of the vehicle, or automatically update the vehicle-side IF version to the target IF version.

A second aspect relates to a communication interface specification update method executed by a computer and applied to automated valet parking of a vehicle in a parking lot.

A parking lot system is a system that manages the automated valet parking in the parking lot. A communication between the vehicle and the parking lot system is required for the automated valet parking.

An IF specification version is a version of a communication interface specification for the communication. A vehicle-side IF version is an IF specification version supported by the vehicle. One or more parking lot-side IF versions are one or more IF specification versions supported by the parking lot system. A target IF version is any of the one or more parking lot-side IF versions.

The communication interface specification update method includes: when the vehicle-side IF version is not included in the one or more parking lot-side IF versions, suggesting updating the vehicle-side IF version to the target IF version to a user of the vehicle, or automatically updating the vehicle-side IF version to the target IF version.

According to the present disclosure, when the vehicle-side IF version is not included in the one or more parking lot-side IF versions, the vehicle-side IF version is automatically updated to the target IF version that is any of the one or more parking lot-side IF versions. Alternatively, updating the vehicle-side IF version to the target IF version is suggested to the user of the vehicle. As a result, the vehicle-side IF version becomes highly likely to match the parking lot-side IF versions. In other words, matching between the vehicle-side IF version and the parking lot-side IF versions is promoted. The matching between the vehicle-side IF version and the parking lot-side IF versions makes it possible to normally start the automated valet parking of the vehicle in the parking lot.

### BRIEF DESCRIPTION OF DRAWINGS

FIG. 1 is a conceptual diagram illustrating an overview of an automated valet parking system;

FIG. 2 is a conceptual diagram for explaining an example of automated valet parking;

FIG. 3 is a conceptual diagram for explaining match and mismatch between versions of communication interface specifications;

FIG. 4 is a conceptual diagram for explaining processing related to communication interface specification update;

FIG. 5 is a flowchart showing a first example of the processing related to the communication interface specification update;

FIG. 6 is a flowchart showing a second example of the processing related to the communication interface specification update;

FIG. 7 is a flowchart showing a third example of the processing related to the communication interface specification update;

FIG. 8 is a flowchart showing still another example of the processing related to the communication interface specification update;

FIG. 9 is a block diagram showing an example of a configuration of an in-vehicle system;

FIG. 10 is a block diagram showing an example of a configuration of a parking lot system; and

FIG. 11 is a block diagram showing an example of a configuration of a back-end system.

### DETAILED DESCRIPTION

Embodiments of the present disclosure will be described with reference to the accompanying drawings.

### 1. AUTOMATED VALET PARKING (AVP) SYSTEM

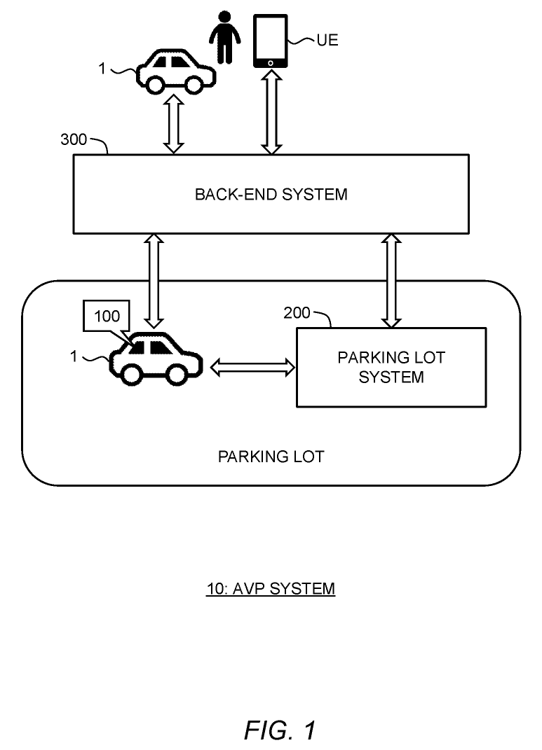

FIG. 1 is a conceptual diagram illustrating an overview of an automated valet parking (AVP: Automated Valet Parking) system 10 according to the present embodiment. The AVP system 10 is a system for the AVP of a vehicle 1 in a parking lot. The AVP system 10 includes an in-vehicle system 100, a parking lot system 200, and a back-end system 300. The in-vehicle system 100, which is mounted on the vehicle 1 being a target of the AVP, controls the vehicle 1. The parking lot system 200, which is an infrastructure system installed in the parking lot, manages the AVP in the parking lot. The back-end system 300 manages the AVP in one or more parking lots, users of the AVP service, and the like. The parking lot system 200 and the back-end system 300 may be collectively referred to as a management system.

In the parking lot, the in-vehicle system 100 and the parking lot system 200 can perform wireless communication with each other. For example, the in-vehicle system 100 and the parking lot system 200 perform wireless communication with each other using a wireless LAN. Moreover, the in-vehicle system 100 and the back-end system 300 can communicate with each other. For example, the in-vehicle system 100 and the back-end system 300 communicate with each other using a mobile communication service. Further, the parking lot system 200 and the back-end system 300 can communicate with each other in a wired or wireless manner. Furthermore, the back-end system 300 and a user terminal UE of a user of the vehicle 1 (that is, a user of the AVP service) can communicate with each other.

An example of a flow of a reservation of the AVP service is as follows. It is assumed that member information of the users is registered in advance in the back-end system 300. First, a user makes a reservation of the AVP. For example, the user operates the user terminal UE to input ID information of the user, a desired parking lot, a desired date of use, a desired time of use (i.e, a scheduled entry time and a scheduled exit time), and the like. The user terminal UE transmits reservation request information including the input information to the back-end system 300. The back-end system 300 executes reservation processing based on the reservation request information, and sends a reservation completion notification to the user terminal UE. In addition, the back-end system 300 provides reservation information to the parking lot system 200 of the reserved parking lot.

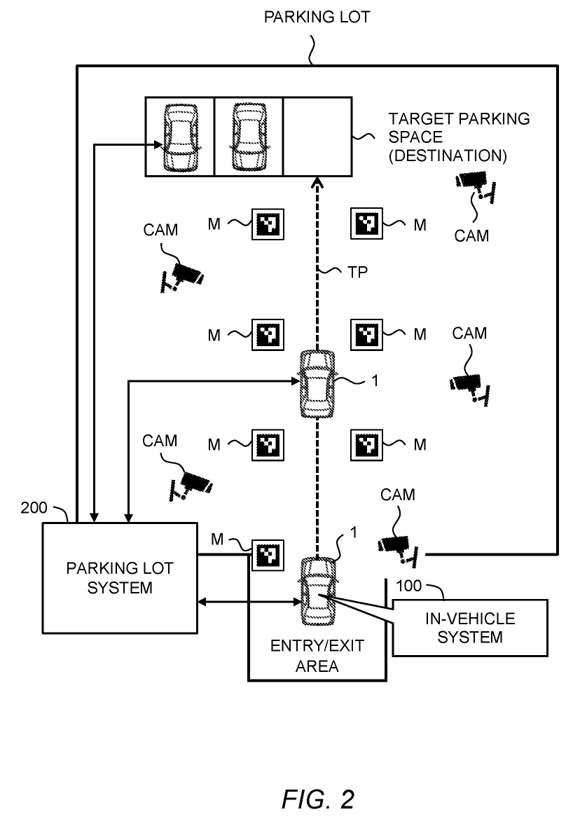

FIG. 2 is a conceptual diagram for explaining an example of the AVP in the parking lot.

The in-vehicle system 100 is mounted on the vehicle 1 and controls the vehicle 1. The in-vehicle system 100 recognizes a situation around the vehicle 1 by using a recognition sensor (for example, a camera) mounted on the vehicle 1. The in-vehicle system 100 makes the vehicle 1 travel safely while recognizing the situation around the vehicle 1. A plurality of markers M (landmarks) may be arranged in the parking lot. The marker M is used for guiding the vehicle 1 in the parking lot. For example, the in-vehicle system 100 acquires an image of the surroundings using the camera, and recognizes the marker M based on the image. Then, based on a result of recognition of the marker M, the in-vehicle system 100 performs localization processing that estimates a position of the vehicle 1 in the parking lot with high accuracy. The in-vehicle system 100 makes the vehicle 1 automatically travel in the parking lot based on the estimated vehicle position.

One or more infrastructure cameras CAM may be installed in the parking lot. The infrastructure camera CAM captures an image of the parking lot and acquires an image showing a situation of the parking lot. The parking lot system 200 communicates with the infrastructure camera CAM to acquire the image captured by the infrastructure camera CAM. The parking lot system 200 analyzes the image to detect the vehicle 1 shown in the image. Moreover, the parking lot system 200 estimates a position of the vehicle 1 shown in the image. Further, the parking lot system 200 manages the vehicle 1 in the parking lot based on the position of the vehicle 1. The parking lot system 200 may provide the position information of the vehicle 1 to the in-vehicle system 100 of the vehicle 1. The in-vehicle system 100 may make the vehicle 1 automatically travel in the parking lot based on the position information provided from the parking lot system 200.

An example of an entry process (check-in) is as follows. The vehicle 1 stops at an entry area. At the entry area, the user gets off the vehicle 1 and requests the entry by using the user terminal UE or the like. The management system (i.e., at least one of the parking lot system 200 and the back-end system 300) conducts authentication of the user and the vehicle 1. Upon completion of the authentication, authority to operate the vehicle 1 is transferred from the user to the management system. The management system communicates with the in-vehicle system 100 and instructs the in-vehicle system 100 to activate the vehicle 1. Moreover, the parking lot system 200 allocates an available parking space to the vehicle 1. The allocated available parking space is a target parking space, that is, a destination for the vehicle 1 at the time of the entry. Further, the parking lot system 200 sets a travel path TP (a target trajectory) from the entry area to the target parking space in the parking lot. The parking lot system 200 sends an entry instruction to the in-vehicle system 100. The entry instruction includes information on the target parking space and the travel path TP. In response to the entry instruction, the in-vehicle system 100 makes the vehicle 1 travel to the target parking space along the travel path TP. That is, the in-vehicle system 100 controls the vehicle 1 to follow the travel path TP based on the vehicle position. Then, the in-vehicle system 100 parks the vehicle 1 in the target parking space. Upon completion of the parking, the management system instructs the in-vehicle system 100 to stop the operation of the vehicle 1.

An example of an exit process (check-out) is as follows. The user requests the exit by using the user terminal UE or the like. The management system communicates with the in-vehicle system 100 and instructs the in-vehicle system 100 to activate the vehicle 1. At the time of exit, a designated exit area is a destination for the vehicle 1. The parking lot system 200 sets a travel path TP (a target trajectory) from the parking space to the exit area in the parking lot. The parking lot system 200 sends an exit instruction to the in-vehicle system 100. The exit instruction includes information on the designated exit area and the travel path TP. In response to the exit instruction, the in-vehicle system 100 makes the vehicle 1 travel to the exit area along the travel path TP. That is, the in-vehicle system 100 controls the vehicle 1 to follow the travel path TP based on the vehicle position. Then, the in-vehicle system 100 stops the vehicle 1 in the exit area. The authority to operate the vehicle 1 is transferred from the management system to the user. The user gets on the vehicle 1. The vehicle 1 starts moving to a next destination.

### 2. MATCHING OF COMMUNICATION INTERFACE SPECIFICATION

In order to realize the AVP in the parking lot, it is necessary to perform the communication between the vehicle 1 (the in-vehicle system 100) and the parking lot system 200. Here, it is desirable that a version of a "communication interface specification" matches between the vehicle 1 (the in-vehicle system 100) side and the parking lot system 200 side. The communication interface specification is defined in, for example, the above-mentioned Non-Patent Literature 1. For example, the communication interface specification includes a sequence of the communications between the in-vehicle system 100 and the parking lot system 200. As another example, the communication interface specification includes types of messages used in the communication between the in-vehicle system 100 and the parking lot system 200. As still another example, the communication interface specification includes a message data protocol in the communication between the in-vehicle system 100 and the parking lot system 200 (see Section 8.2 AVP Message Data Protocol in Non-Patent Literature 1). These communication interface specifications may vary from version to version.

In the following description, the version of the communication interface specification for the communication between the vehicle 1 (the in-vehicle system 100) and the parking lot system 200 is referred to as an "IF specification version." The IF specification version supported by the vehicle 1 (the in-vehicle system 100) is hereinafter referred to as a "vehicle-side IF version". It can also be said that the vehicle-side IF version is an IF specification version that is available in the vehicle 1 (in-vehicle system 100). One or more IF specification versions supported by the parking lot system 200 are hereinafter referred to as a "parking lot-side IF version". It can also be said that the parking lot-side IF version is an IF specification version that are available in the parking lot system 200. Multiple parking lot-side IF versions may be supported by the parking lot system 200. On the other hand, due to a capacity of resources of an ECU mounted on the in-vehicle system 100, the in-vehicle system 100 is likely to support only one vehicle-side IF version. However, in some cases, the in-vehicle system 100 may support multiple vehicle-side IF versions.

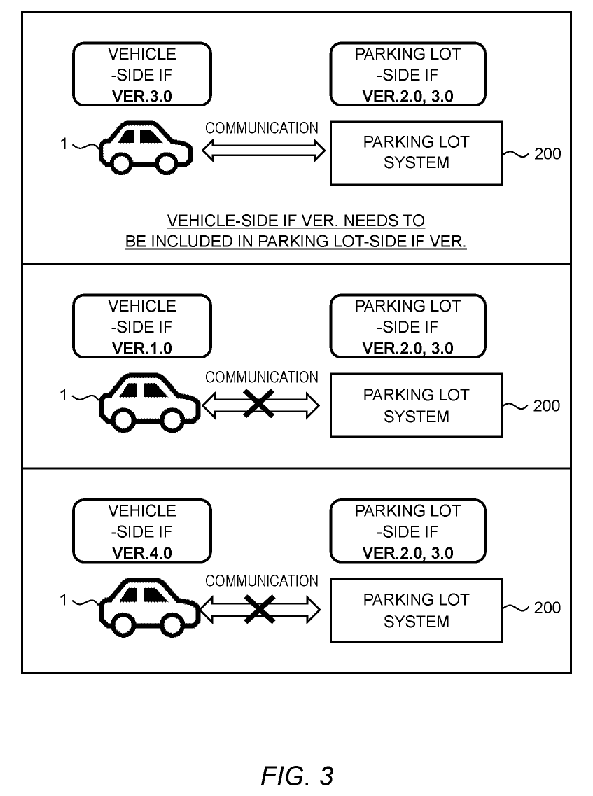

FIG. 3 is a conceptual diagram for explaining match and mismatch between the vehicle-side IF version and the parking lot-side IF version. The vehicle-side IF version matching the parking lot-side IF version means that the vehicle-side IF version is included in the one or more parking lot-side IF versions. In other words, the vehicle-side IF version matching the parking lot-side IF version means that the vehicle-side IF version is the same as any of the one or more parking lot-side IF versions. On the other hand, the vehicle-side IF version not matching the parking lot-side IF version means that the vehicle-side IF version is not included in the one or more parking lot-side IF versions. In other words, the vehicle-side IF version not matching the parking lot-side IF version means that the vehicle-side IF version is different from any of the one or more parking lot-side IF versions. For example, in the example shown in FIG. 3, the parking lot-side IF versions include Version 2.0 and Version 3.0. When the vehicle-side IF version is Version 3.0, the vehicle-side IF version matches the parking lot-side IF versions. On the other hand, when the vehicle-side IF version is Version 1.0, the vehicle-side IF version does not match the parking lot-side IF versions. When the vehicle-side IF version is Version 4.0, the vehicle-side IF version does not match the parking lot-side IF versions.

Prior to starting the AVP of the vehicle 1 (i.e., a target vehicle) in the parking lot, the AVP system 10 confirms that the vehicle-side IF version and the parking lot-side IF version match each other. For example, the in-vehicle system 100 and the parking lot system 200 establish a transport layer security (TLS) connection in response to a request from the back-end system 300. Within a predetermined time (for example, 10 seconds) after the TLS connection is established, the in-vehicle system 100 and the parking lot system 200 confirm whether the respective IF specification versions match each other. If it is not confirmed within the predetermined time, or if the respective IF specification versions do not match, the AVP system 10 aborts the AVP of the vehicle 1 (i.e., the target vehicle) and notifies the user of the aborting. That is, when the vehicle-side IF version and the parking lot-side IF version do not match, it is not possible to start the AVP.

In view of the above, the present embodiment proposes a technique capable of promoting matching between the vehicle-side IF version and the parking lot-side IF version.

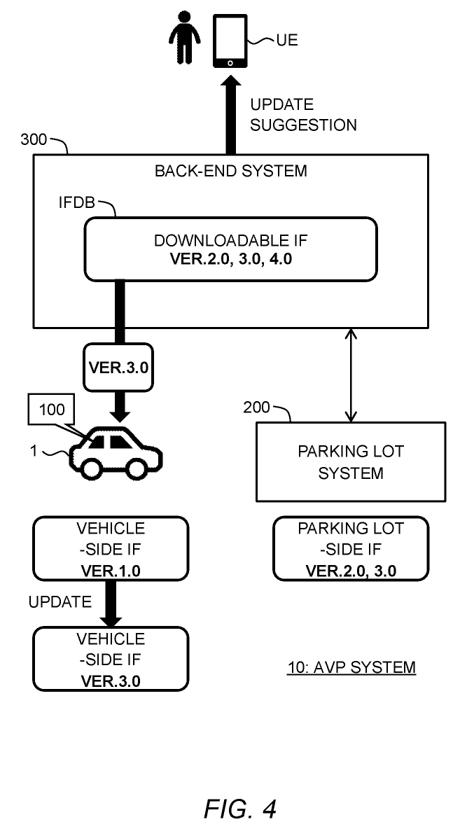

FIG. 4 is a conceptual diagram for explaining processing related to communication interface specification update according to the present embodiment. In the example shown in FIG. 4, the vehicle-side IF version is Version 1.0, and the parking lot-side IF versions include Version 2.0 and Version 3.0. That is, the vehicle-side IF version does not match the parking lot-side IF versions. First, the AVP system 10 recognizes that the vehicle-side IF version does not match the parking lot-side IF versions.

For example, a comparison between the vehicle-side IF version and the parking lot-side IF versions is made in advance before the vehicle 1 arrives at the parking lot. Information on the vehicle-side IF version is obtained from the in-vehicle system 100. Information on the parking lot-side IF versions is obtained from the parking lot system 200. The back-end system 300 can communicate with the in-vehicle system 100 and the parking lot system 200, and thus can obtain the information on the vehicle-side IF version and the information on the parking lot-side IF versions. Therefore, the back-end system 300 may make the comparison between the vehicle-side IF version and the parking lot-side IF versions. As another example, the in-vehicle system 100 may obtain the information on the parking lot-side IF versions from the parking lot system 200 via the back-end system 300, and make the comparison between the vehicle-side IF version and the parking lot-side IF versions. As still another example, the parking lot system 200 may obtain the information on the vehicle-side IF version from the in-vehicle system 100 via the back-end system 300, and make the comparison between the vehicle-side IF version and the parking lot-side IF versions. That is, processing entity making the comparison can be any of the in-vehicle system 100, the parking lot system 200, and the back-end system 300. In this sense, it can be said that the AVP system 10 makes the comparison between the vehicle-side IF version and the parking lot-side IF versions. The AVP system 10 makes the comparison between the vehicle-side IF version and the parking lot-side IF versions before the vehicle 1 arrives at the parking lot, and recognizes that the vehicle-side IF version does not match the parking lot-side IF versions.

Alternatively, after the vehicle 1 arrives at the parking lot, the AVP system 10 may recognize that the vehicle-side IF version does not match the parking lot-side IF versions. For example, after the vehicle 1 arrives at the parking lot, the in-vehicle system 100 and the parking lot system 200 establish a TLS connection in response to a request from the back-end system 300. Within a predetermined time after the TLS connection is established, the in-vehicle system 100 and the parking lot system 200 checks whether the respective IF specification versions match each other. At this stage, mismatch between the vehicle-side IF version and the parking lot-side IF versions may be recognized.

The back-end system 300 holds and manages a database of the communication interface specifications. The database is hereinafter referred to as IFDB. The in-vehicle system 100 is able to communicate with the back-end system 300, download data of any communication interface specification managed by the IFDB, and implement the downloaded communication interface specification, as needed. That is to say, the in-vehicle system 100 is able to update the vehicle-side IF version by software update (SU) as necessary.

When the vehicle-side IF version does not match the parking lot-side IF versions, it is desirable to update the vehicle-side IF version. The vehicle-side IF version after the update needs to be any one of the parking lot-side IF versions. Any one of the parking lot-side IF versions is hereinafter referred to as a "target IF version". When the communication interface specification of the target IF version is managed by the IFDB, the in-vehicle system 100 is able to download data of the communication interface specification of the target IF version and update the vehicle-side IF version to the target IF version. It should be noted that in some cases, the target IF version may be older than the vehicle-side IF version before the update. In that case, the vehicle-side IF version is downgraded to the target IF version, but this is also included in the concept of "update" in the present embodiment.

For example, the AVP system 10 "automatically" updates the vehicle-side IF version to the target IF version. More specifically, the in-vehicle system 100 communicates with the back-end system 300, downloads data of the communication interface specification of the target IF version from the back-end system 300, and then automatically updates the vehicle-side IF version to the target IF version. When the back-end system 300 recognizes a mismatch between the vehicle-side IF version and the parking lot-side IF versions, the back-end system 300 may instruct the in-vehicle system 100 to update the vehicle-side IF version to the target IF version. When the parking lot system 200 recognizes a mismatch between the vehicle-side IF version and the parking lot-side IF versions, the parking lot system 200 may instruct the in-vehicle system 100 via the back-end system 300 to update the vehicle-side IF version to the target IF version. In either case, it is possible to update the vehicle-side IF version to the target IF version.

As another example, the AVP system 10 may suggest updating the vehicle-side IF version to the target IF version to the user of vehicle 1. More specifically, the back-end system 300 communicates with the user terminal UE of the user and sends an "update suggestion notification" to the user terminal UE. The update suggestion notification suggests updating the vehicle-side IF version to the target IF version. When the in-vehicle system 100 recognizes a mismatch between the vehicle-side IF version and the parking lot-side IF versions, the in-vehicle system 100 may request the back-end system 300 to send the update suggestion notification. When the parking lot system 200 recognizes a mismatch between the vehicle-side IF version and the parking lot-side IF versions, the parking lot system 200 may request the back-end system 300 to send the update suggestion notification. In either case, it is possible to send the update suggestion notification to the user terminal UE. The user who has received the update suggestion notification approves or rejects updating the vehicle-side IF version. When the user approves updating the vehicle-side IF version, the back-end system 300 receives an approval response from the user terminal UE. Then, the back-end system 300 instructs the in-vehicle system 100 to update the vehicle-side IF version to the target IF version.

As described above, according to the present embodiment, when the vehicle-side IF version is not included in the one or more parking lot-side IF versions, the vehicle-side IF version is automatically updated to the target IF version that is any of the one or more parking lot-side IF versions. Alternatively, updating the vehicle-side IF version to the target IF version is suggested to the user of the vehicle. As a result, the vehicle-side IF version becomes highly likely to match the parking lot-side IF versions. In other words, matching between the vehicle-side IF version and the parking lot-side IF versions is promoted. The matching between the vehicle-side IF version and the parking lot-side IF versions makes it possible to normally start the AVP of the vehicle 1 in the parking lot.

### 3. EXAMPLES OF PROCESSING FLOW

Examples of a processing flow according to the present embodiment will be described below. As described above, the processing entity may be any of the in-vehicle system 100, the parking lot system 200, and the back-end system 300, or may be a combination of two or more of them. The reason is that the back-end system 300 can communicate with the in-vehicle system 100 and the parking lot system 200, and a variety of information can be shared among the in-vehicle system 100, the parking lot system 200, and the back-end system 300. In the following description, the processing entity is expressed as the "AVP system 10", which means that the processing entity may be any of the in-vehicle system 100, the parking lot system 200, and the back-end system 300, or may be a combination of two or more of them. More generally, the processing entity may be referred to as "one or more processors" or "processing circuitry".

### 3-1. First Example

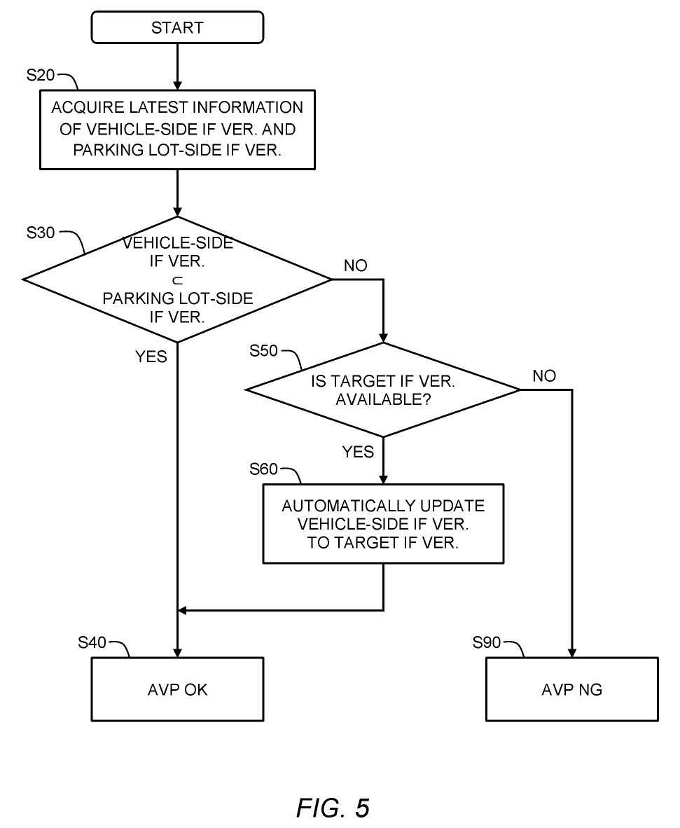

FIG. 5 is a flowchart showing a first example of the processing flow related to the communication interface specification update according to the present embodiment.

In Step S20, the AVP system 10 acquires latest information of the vehicle-side IF version from the in-vehicle system 100 of the vehicle 1 (i.e., the target vehicle). In addition, the AVP system 10 acquires latest information of the one or more parking lot-side IF versions from the parking lot system 200.

In Step S30, the AVP system 10 compares the acquired vehicle-side IF version with the acquired parking lot-side IF versions to determine whether the vehicle-side IF version is included in the parking lot-side IF versions. In other words, the AVP system 10 determines whether the current vehicle-side IF version matches the parking lot-side IF versions. When the vehicle-side IF version is included in the parking lot-side IF versions, that is, when the vehicle-side IF version matches the parking lot-side IF versions (Step S30; Yes), the processing proceeds to Step S40. On the other hand, when the vehicle-side IF version is not included in the parking lot-side IF versions, that is, when the vehicle-side IF version does not match the parking lot-side IF versions (Step S30; No), the processing proceeds to Step S50.

### IN STEP S40, THE AVP SYSTEM 10 PERMITS THE AVP OF THE VEHICLE 1 (THE TARGET VEHICLE).

In Step S50, the AVP system 10 determines whether or not the target IF version, which is any of the parking lot-side IF versions, is available. When the communication interface specification of the target IF version is included in the IFDB of the back-end system 300, the target IF version is available. When the target IF version is available (Step S50; Yes), the processing proceeds to Step S60. On the other hand, when the target IF version is not available (Step S50; No), the processing proceeds to Step S90.

In Step S60, the AVP system 10 acquires the communication interface specification of the target IF version from the IFDB of the back-end system 300. Then, the AVP system 10 automatically updates the vehicle-side IF version to the target IF version. Thereafter, the processing proceeds to Step S40.

### IN STEP S90, THE AVP SYSTEM 10 PROHIBITS THE AVP OF THE VEHICLE 1 (THE TARGET VEHICLE).

### 3-2. Second Example

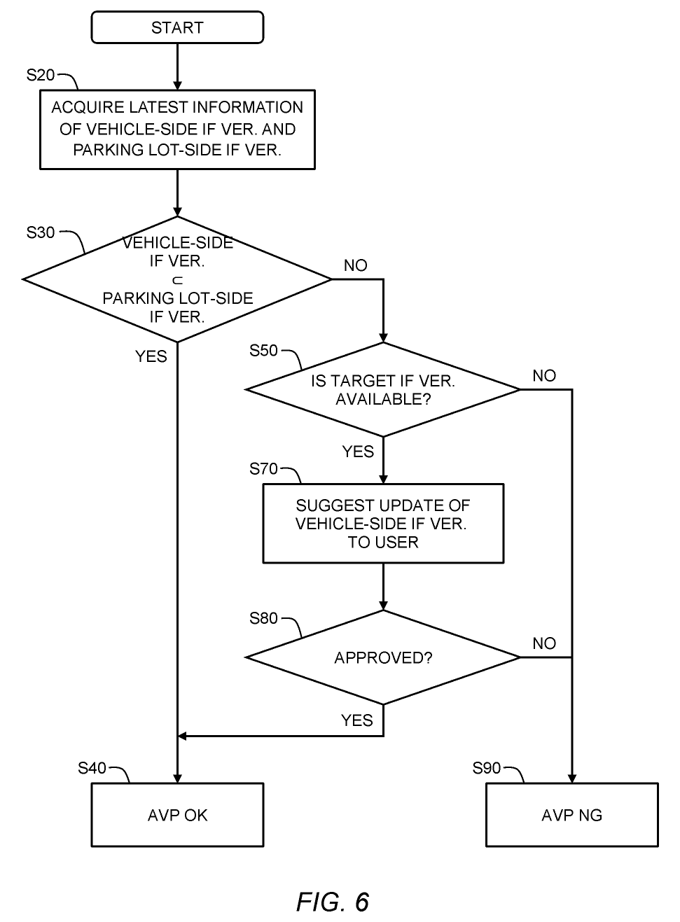

FIG. 6 is a flowchart showing a second example of the processing flow related to the communication interface specification update according to the present embodiment. The description overlapping with the first example described above will be omitted as appropriate.

In Step S50, the AVP system 10 determines whether or not the target IF version, which is any of the parking lot-side IF versions, is available. When the target IF version is available (Step S50; Yes), the processing proceeds to Step S70.

In Step S70, the AVP system 10 suggests updating the vehicle-side IF version to the target IF version to the user of the vehicle 1 (the target vehicle). More specifically, the AVP system 10 transmits, to the user terminal UE of the user, an update suggestion notification that suggests updating the vehicle-side IF version to the target IF version. The user terminal UE sends back a user response indicating approval or rejection of the user to the AVP system 10.

In Step S80, the AVP system 10 determines whether the user has approved the update of the vehicle-side IF version. When the user rejects the update of the vehicle-side IF version (Step S80; No), the processing proceeds to Step S90.

On the other hand, when the user approves the update of the vehicle-side IF version (Step S80; Yes), the processing proceeds to Step S40. In Step S40, the AVP system 10 permits the AVP of the vehicle 1 (the target vehicle). The AVP system 10 updates the vehicle-side IF version to the target IF version before the AVP is started.

### 3-3. Third Example

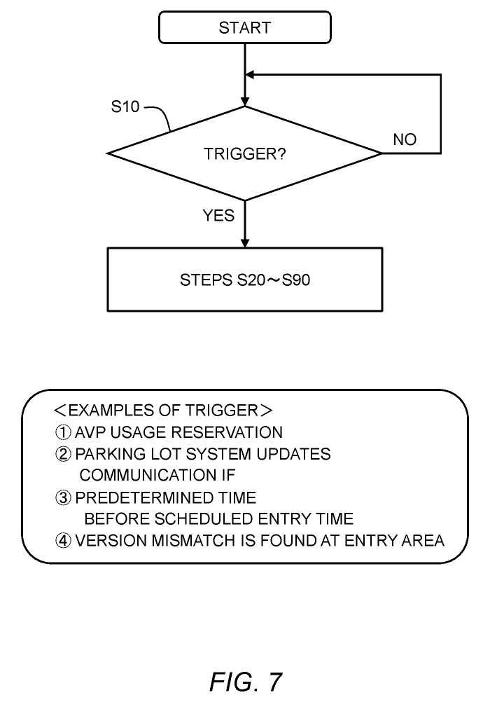

FIG. 7 is a flowchart showing a third example of the processing related to the communication interface specification update. The description overlapping with the first example and the second example described above will be omitted as appropriate.

In Step S10, the AVP system 10 determines whether a predetermined trigger occurs. When the predetermined trigger occurs (Step S10; Yes), the AVP system 10 executes the processing described in the first example or the second example described above. That is, the AVP system 10 executes the processing described in the first example or the second example in response to the predetermined trigger.

A first example of the predetermined trigger is that the user requests a reservation of the AVP in the parking lot. When requesting the reservation of the AVP, the user operates the user terminal UE to input the ID information of the user, a desired parking lot, a desired date of use, a desired time of use (i.e., a scheduled entry time and a scheduled exit time), and the like. The user terminal UE transmits reservation request information including the input information to the back-end system 300. When the back-end system 300 receives the reservation request information, the AVP system 10 determines that the predetermined trigger has occurred.

A second example of the predetermined trigger is that the one or more parking lot-side IF versions are updated in the parking lot system 200. An administrator of the parking lot system 200 may update the parking lot-side IF versions at any timing. When the parking lot system 200 detects the update of the parking lot IF versions, the AVP system 10 determines that the predetermined trigger has occurred. In this case, the AVP system 10 may perform the processing described in the first example or the second example described above with respect to the vehicles 1 of all users who may use the AVP.

After a reservation of the AVP of a vehicle 1 in a certain parking lot is completed, the parking lot-side IF versions may be updated in the parking lot system 200 of the certain parking lot before the vehicle 1 arrives at the certain parking lot. In this case, the AVP system 10 may perform the processing described in the first example or the second example described above with respect to the vehicle 1 of the user who has made the AVP reservation.

A third example of the predetermined trigger is that a trigger time has come. The trigger time is a predetermined time (for example, several hours) before the scheduled entry time designated by the user at the time of reservation. When the trigger time has come, the AVP system 10 determines that the predetermined trigger has occurred.

A fourth example of the predetermined trigger is that a mismatch between the vehicle-side IF version and the parking lot-side IF versions is found at the entry area after the vehicle 1 arrives at the parking lot. At the entry area, the in-vehicle system 100 and the parking lot system 200 establish a TLS connection in accordance with a request from the back-end system 300. Within a predetermined time (for example, 10 seconds) after the TLS connection is established, the in-vehicle system 100 and the parking lot system 200 confirm whether the respective IF specification versions match each other. When the mismatch between the vehicle-side IF version and the parking lot-side IF versions is found at this stage, the AVP system 10 determines that the predetermined trigger has occurred.

### 3-4. Fourth Example

The case of the above-described first example of the predetermined trigger, that is., the case where the predetermined trigger is that "the user requests a reservation of the AVP in the parking lot" will be described in more detail.

When the vehicle-side IF version matches the parking lot-side IF versions in Step S30 (Step S30; Yes), the processing proceeds to Step S40. In Step S40, the AVP system 10 accepts the reservation requested by the user. In addition, the AVP system 10 notifies, through the user terminal UE, the user that the reservation has been normally accepted.

When the target IF version is not available in Step S50 (Step S50; No), the processing proceeds to Step S90. In Step S90, the AVP system 10 refrains from accepting the reservation requested by the user. In addition, the AVP system 10 notifies, through the user terminal UE, the user that the reservation cannot be accepted.

In Step S60, when the vehicle-side IF version is automatically updated to the target IF version, the processing proceeds to Step S40. In Step S40, the AVP system 10 accepts the reservation requested by the user. In addition, the AVP system 10 notifies, through the user terminal UE, the user that the reservation has been normally accepted.

When the user approves updating the vehicle-side IF version in Step S80 (Step S80; Yes), the processing proceeds to Step S40. In Step S40, the AVP system 10 accepts the reservation requested by the user. In addition, the AVP system 10 notifies, through the user terminal UE, the user that the reservation has been normally accepted. After that, the AVP system 10 updates the vehicle-side IF version to the target IF version before the AVP is started.

When the user rejects updating the vehicle-side IF version in Step S80 (Step S80; No), the processing proceeds to Step S90. In Step S90, the AVP system 10 refrains from accepting the reservation requested by the user. In addition, the AVP system 10 notifies, through the user terminal UE, the user that the reservation cannot be accepted.

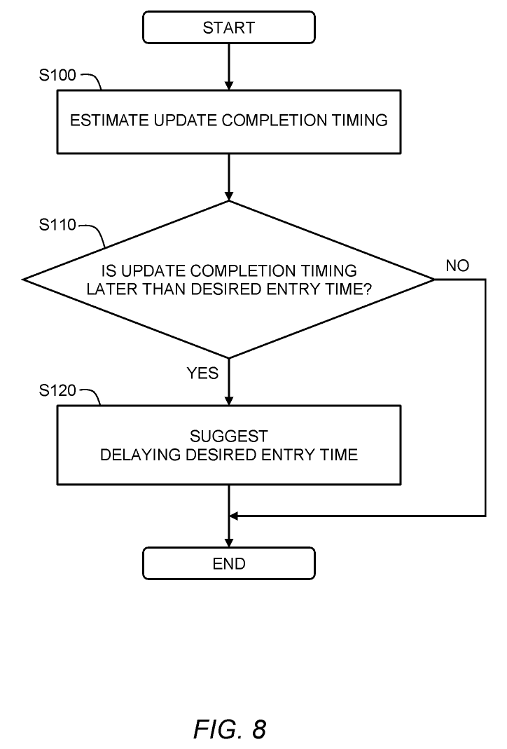

FIG. 8 is a flowchart showing still another example of the processing related to the communication interface specification update. In Step S100, the AVP system 10 estimates an update completion timing at which updating the vehicle-side IF version to the target IF version is completed. For example, a time required for updating the vehicle-side IF version to the target IF version is several minutes. In Step S110, the AVP system 10 determines whether or not the update completion timing is later than the desired entry time designated in the reservation. When the update completion timing is later than the desired entry time designated in the reservation (Step S110; Yes), the processing proceeds to Step S120. In Step S120, the AVP system 10 suggests delaying the desired entry time to the user through the user equipment UE.

### 4. CONFIGURATION EXAMPLE

### 4-1. Configuration Example of In-Vehicle System

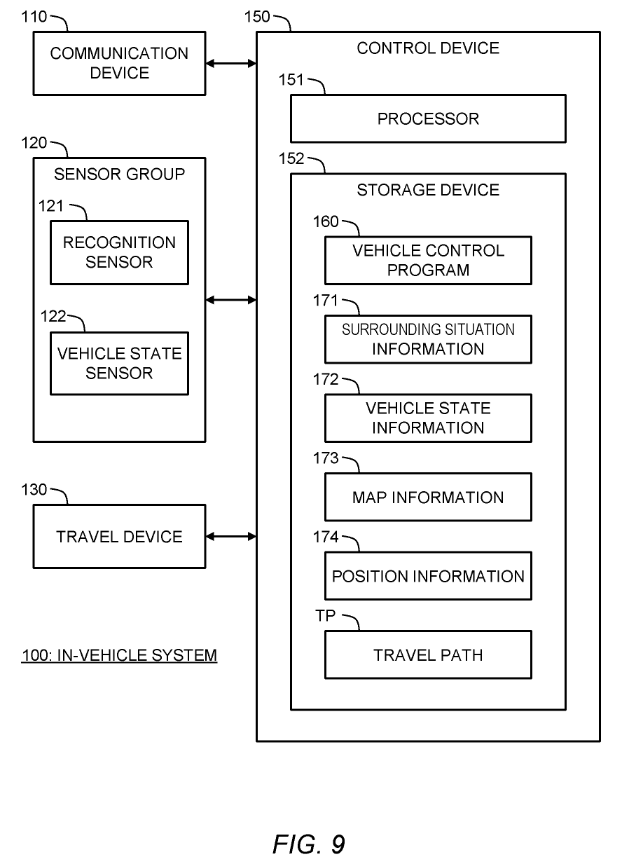

FIG. 9 is a block diagram showing a configuration example of the in-vehicle system 100 according to the present embodiment. The in-vehicle system 100 includes a communication device 110, a sensor group 120, a travel device 130, and a control device 150.

The communication device 110 communicates with the outside via a communication network. For example, the communication device 110 communicates with the parking lot system 200 of the parking lot via a wireless LAN. In addition, the communication device 110 communicates with the back-end system 300.

The sensor group 120 includes a recognition sensor 121, a vehicle state sensor 122, and the like. The recognition sensor 121 is used for recognizing (detecting) a situation around the vehicle 1. Examples of the recognition sensor 121 include a camera, a laser imaging detection and ranging (LIDAR), a radar, and the like. The vehicle state sensor 122 includes a speed sensor, an acceleration sensor, a yaw rate sensor, a steering angle sensor, and the like.

The travel device 130 includes a steering device, a driving device, and a braking device. The steering device turns wheels. For example, the steering device includes an electric power steering (EPS) device. The driving device is a power source that generates a driving force. Examples of the driving device include an engine, an electric motor, an in-wheel motor, and the like. The braking device generates a braking force.

The control device 150 is a computer that controls the vehicle 1. The control device 150 includes one or more processors 151 (hereinafter, simply referred to as a processor 151) and one or more storage devices 152 (hereinafter, simply referred to as a storage device 152). The processor 151 executes a variety of processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, and / or a combination thereof. The processor 151 may also be referred to as processing circuitry. The storage device 152 stores a variety of information. Examples of the storage device 152 include a volatile memory, a nonvolatile memory, a hard disk drive (HDD), a solid state drive (SSD), and the like.

A vehicle control program 160 is a computer program for controlling the vehicle 1. The functions of the control device 150 may be realized by a cooperation between the processor 151 executing the vehicle control program 160 and the storage device 152. The vehicle control program 160 is stored in the storage device 152. Alternatively, the vehicle control program 160 may be recorded on a non-transitory computer-readable recording medium.

The control device 150 executes vehicle travel control for controlling travel of the vehicle 1. The vehicle travel control includes steering control, acceleration control, and deceleration control. The control device 150 executes the vehicle travel control by controlling the travel device 130 (i.e., the steering device, the driving device, and the braking device).

Moreover, the control device 150 communicates with the parking lot system 200 and the back-end system 300 via the communication device 110. The storage device 152 may store information of the version of the communication interface specification of the in-vehicle system 100, that is, the vehicle-side IF version. The control device 150 may execute the processing related to the communication interface specification update described in the above Section 2 and Section 3.

The control device 150 acquires a variety of information. A variety of information is stored in the storage device 152.

Surrounding situation information 171 indicates the result of recognition by the recognition sensor 121. The surrounding situation information 171 may include object information regarding an object recognized by the recognition sensor 121. Examples of the object around the vehicle 1 include an obstacle, a white line, a marker M, and the like. Examples of the obstacle include a wall, a pillar, another vehicle, and the like. The object information indicates a relative position and a relative speed of the object with respect to the vehicle 1.

Vehicle state information 172 indicates the vehicle state detected by the vehicle state sensor 122. Examples of the vehicle state include a speed, an acceleration, a yaw rate, a steering angle, and the like.

Map information 173 is map information of the parking lot in which the vehicle 1 travels. The map information 173 indicates an arrangement of roads in the parking lot. In addition, the map information 173 indicates an arrangement of stationary obstacles (for example, walls and pillars) in the parking lot. The map information 173 further indicates an arrangement of the markers M in the parking lot. For example, the map information 173 is provided from the parking lot system 200 that manages the parking lot. The control device 150 acquires the map information 173 from the parking lot system 200 via the communication device 110.

Position information 174 indicates a current position of the vehicle 1 in the parking lot. For example, the control device 150 acquires the position information 174 with high accuracy by performing localization processing (Localization). More specifically, the control device 150 calculates a rough position of the vehicle 1 in the parking lot based on the vehicle state information 172 (specifically, the steering angle and the speed). Moreover, the control device 150 recognizes the marker M around the vehicle 1 by using the recognition sensor 121. In addition, the control device 150 acquires the arrangement information of the markers M around the vehicle 1 from the map information 173. The control device 150 corrects the position of the vehicle 1 by matching the recognition result of the marker M with the arrangement of the markers M. Accordingly, the position information 174 with high accuracy is obtained.

Alternatively, the position information 174 of the vehicle 1 may be estimated by the parking lot system 200 based on the image captured by the infrastructure camera CAM. In this case, the control device 150 may acquire the position information 174 from the parking lot system 200 via the communication device 110.

The control device 150 acquires information on the travel path TP in the parking lot. For example, the travel path TP is determined by the parking lot system 200, and the control device 150 acquires information on the travel path TP from the parking lot system 200 via the communication device 110. As another example, the control device 150 may determine the travel path TP based on the map information 173 and the position information 174. Then, the control device 150 executes the vehicle travel control based on the position information 174 such that the vehicle 1 travels along the travel path TP.

### 4-2. Configuration Example of Parking Lot System

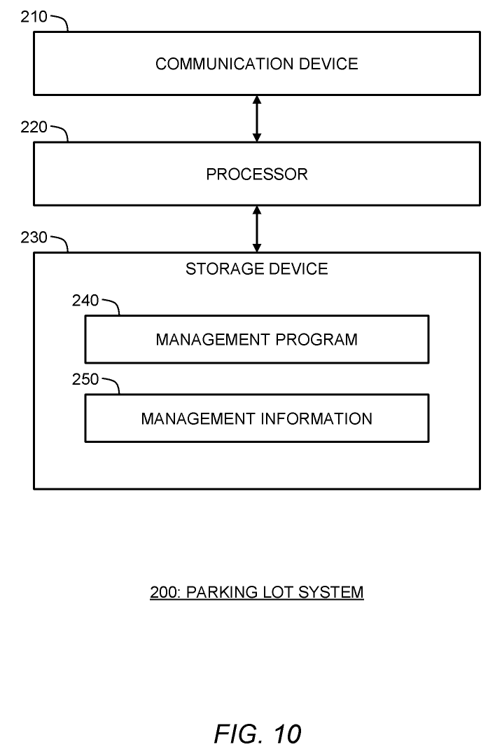

FIG. 10 is a block diagram showing a configuration example of the parking lot system 200 according to the present embodiment. The parking lot system 200 includes a communication device 210, one or more processors 220 (hereinafter simply referred to as a processor 220), and one or more storage devices 230 (hereinafter simply referred to as a storage device 230).

The communication device 210 communicates with the in-vehicle system 100 of each vehicle 1. For example, the communication device 210 communicates with the in-vehicle system 100 via a wireless LAN. In addition, the communication device 210 communicates with the back-end system 300. Further, the communication device 210 may communicate with the infrastructure camera CAM installed in the parking lot.

The processor 220 executes a variety of processing. Examples of the processor 220 include a general purpose processor, a special purpose processor, a CPU, a GPU, an ASIC, an FPGA, an integrated circuit, and / or combinations thereof. The processor 220 may also be referred to as processing circuitry. The storage device 230 stores a variety of information. Examples of the storage device 230 include a volatile memory, a nonvolatile memory, an HDD, an SSD, and the like.

A management program 240 is a computer program for managing the parking lot. The functions of the parking lot system 200 may be realized by a cooperation between the processor 220 executing the management program 240 and the storage device 230. The management program 240 is stored in the storage device 230. The management program 240 may be recorded on a non-transitory computer-readable recording medium.

The processor 220 communicates with the in-vehicle system 100 and the back-end system 300 via the communication device 210. The storage device 230 may store information on the version of the communication interface specification of the parking lot system 200, that is, the parking lot-side IF version. The processor 220 may execute the processing related to the communication interface specification update described in the above Section 2 and Section 3.

The storage device 230 stores management information 250 for managing the parking lot. The management information 250 includes map information of the parking lot. The map information is similar to the map information 173 described above. The processor 220 may provide the map information to the in-vehicle system 100 via the communication device 210. Moreover, the management information 250 indicates a usage status (vacancy status) of the parking spaces in the parking lot. The processor 220 can allocate an available parking space (destination) to the vehicle 1 based on the management information 250.

The management information 250 may further include vehicle management information. The vehicle management information includes the position information 174 of each vehicle 1 in the parking lot. The processor 220 may communicate with each vehicle 1 via the communication device 210 and collect the position information 174 from each vehicle 1. Alternatively, the processor 220 may acquire the image captured by the infrastructure camera CAM installed in the parking lot and estimate the position of each vehicle 1 based on the image. The vehicle management information may include the travel path TP allocated to each vehicle 1. The processor 220 can determine the travel path TP allocated to each vehicle 1 based on the position information 174 of the vehicle 1, the destination, and the map information. The processor 220 may provide the information on the travel path TP to the in-vehicle system 100 of the vehicle 1 via the communication device 210.

### 4-3. Configuration Example of Back-End System

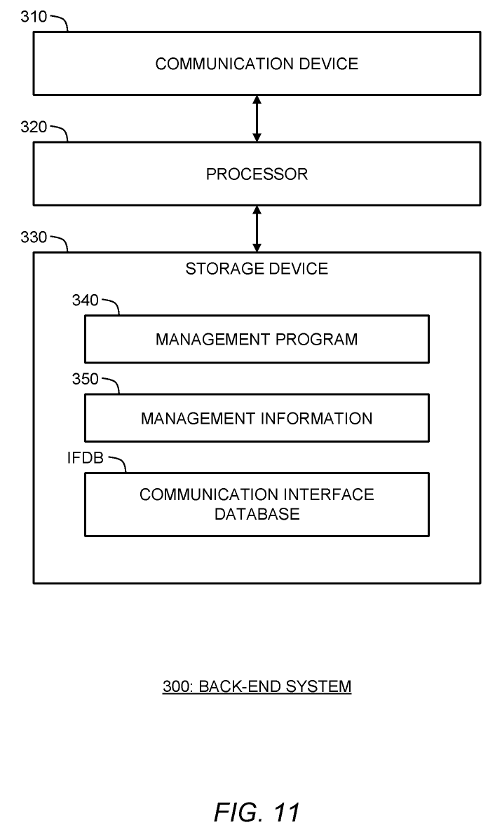

FIG. 11 is a block diagram showing a configuration example of the back-end system 300 according to the present embodiment. The back-end system 300 includes a communication device 310, one or more processors 320 (hereinafter simply referred to as a processor 320), and one or more storage devices 330 (hereinafter simply referred to as a storage device 330).

The communication device 310 communicates with the in-vehicle system 100 of each vehicle 1. In addition, the communication device 310 communicates with the parking lot system 200 of each parking lot. Further, the communication device 310 communicates with the user terminal UE of each user.

The processor 320 executes a variety of processing. Examples of the processor 320 include a general purpose processor, a special purpose processor, a CPU, a GPU, an ASIC, an FPGA, an integrated circuit, and / or combinations thereof. The processor 320 may also be referred to as processing circuitry. The storage device 330 stores a variety of information. Examples of the storage device 330 include a volatile memory, a nonvolatile memory, an HDD, an SSD, and the like.

A management program 340 is a computer program for managing the AVP in the parking lot. The functions of the back-end system 300 may be realized by a cooperation between the processor 320 executing the management program 340 and the storage device 330. The management program 340 is stored in the storage device 330. The management program 340 may be recorded on a non-transitory computer-readable recording medium.

The storage device 330 stores management information 350. The management information 350 may include the user information and the reservation information regarding each user. The management information 350 may include facility information and reservation status information regarding each parking lot. When the processor 320 receives the reservation request information from the user, the processor 320 may perform a reservation process based on the management information 350.

Moreover, the storage device 330 stores the communication interface specification database IFDB. The processor 320 communicates with the in-vehicle system 100 and the parking lot system 200 via the communication device 310. The processor 320 may execute the processing related to the communication interface specification update described in the above Section 2 and Section 3.

What is claimed is:

1. An automated valet parking system for automated valet parking of a vehicle in a parking lot, wherein
a parking lot system is a system that manages the automated valet parking in the parking lot,
communication between the vehicle and the parking lot system is required for the automated valet parking,
an IF specification version is a version of a communication interface specification for the communication,
a vehicle-side IF version is an IF specification version supported by the vehicle,
one or more parking lot-side IF versions are one or more IF specification versions supported by the parking lot system, and
a target IF version is any of the one or more parking lot-side IF versions,
the automated valet parking system comprising processing circuitry configured to:
when the vehicle-side IF version is not included in the one or more parking lot-side IF versions, suggest updating the vehicle-side IF version to the target IF version to a user of the vehicle, or automatically update the vehicle-side IF version to the target IF version.

2. The automated valet parking system according to claim 1, wherein
the processing circuitry is further configured to:
acquire latest information of the vehicle-side IF version and latest information of the one or more parking lot-side IF versions; and
compares the acquired vehicle-side IF version with the acquired one or more parking lot-side IF versions to determine whether the vehicle-side IF version is included in the one or more parking lot-side IF versions.

3. The automated valet parking system according to claim 1, wherein
the processing circuitry is further configured to:
acquire latest information of the vehicle-side IF version and latest information of the one or more parking lot-side IF versions in response to a predetermined trigger; and
compare the acquired vehicle-side IF version with the acquired one or more parking lot-side IF versions to determine whether the vehicle-side IF version is included in the one or more parking lot-side IF versions.

4. The automated valet parking system according to claim 3, wherein
the predetermined trigger includes that the user requests a reservation of the automated valet parking in the parking lot.

5. The automated valet parking system according to claim 4, wherein
the processing circuitry is further configured to, when the target IF version is not available, refrain from accepting the reservation and notify the user that the reservation cannot be accepted.

6. The automated valet parking system according to claim 4, wherein
the processing circuitry is further configured to accept the reservation, when the user approves updating the vehicle-side IF version to the target IF version, or when the vehicle-side IF version is automatically updated to the target IF version.

7. The automated valet parking system according to claim 4, wherein
the processing circuitry is further configured to:
estimate an update completion timing at which updating the vehicle-side IF version to the target IF version is completed; and
when the update completion timing is later than a desired entry time specified in the reservation, suggest delaying the desired entry time to the user.

8. The automated valet parking system according to claim 4, wherein
the predetermined trigger further includes that the one or more parking lot-side IF versions are updated in the parking lot system after completion of the reservation.

9. The automated valet parking system according to claim 3, wherein
the predetermined trigger includes that the one or more parking lot-side IF versions are updated in the parking lot system.

10. A communication interface specification update method executed by a computer and applied to automated valet parking of a vehicle in a parking lot, wherein
a parking lot system is a system that manages the automated valet parking in the parking lot,
communication between the vehicle and the parking lot system is required for the automated valet parking,
an IF specification version is a version of a communication interface specification for the communication,
a vehicle-side IF version is an IF specification version supported by the vehicle,
one or more parking lot-side IF versions are one or more IF specification versions supported by the parking lot system, and
a target IF version is any of the one or more parking lot-side IF versions,
the communication interface specification update method comprising:
when the vehicle-side IF version is not included in the one or more parking lot-side IF versions, suggesting updating the vehicle-side IF version to the target IF version to a user of the vehicle, or automatically updating the vehicle-side IF version to the target IF version.
